(19) United States
(12) Patent Application Publication
(10) Pub. No.: US 2024/0019979 A1
(43) Pub. Date: Jan. 18, 2024

(54) CONVERSION OF 3D VIRTUAL ACTIONS INTO 2D ACTIONS

(71) Applicant: Lenovo (Singapore) Pte. Ltd., Singapore (SG)

(72) Inventors: Kuldeep Singh, Morrisville, NC (US); Raju Kandaswamy, Morrisville, NC (US); Mandal Neelarghya, Morrisville, NC (US); Shay May-Raz Mayan, Morrisville, NC (US); Andrew Hansen, Morrisville, NC (US); Cole Heiner, Morrisville, NC (US); Siddarth Kengadaran, Morrisville, NC (US)

(21) Appl. No.: 17/812,913

(22) Filed: Jul. 15, 2022

(51) Int. Cl. G06F 3/04815; G06F 3/01; G06F 8/20; G02B 27/01

(52) U.S. Cl. CPC G06F 3/04815; G06F 3/011; G06F 8/20; G02B 27/017

(57) ABSTRACT

In one aspect, at least one device includes at least one processor and storage accessible to the at least one processor. The storage includes instructions executable by the at least one processor to execute a first application (app) at the first device, where the first app is configured for converting actions in three dimensional (3D) space into actions in two dimensional (2D) space. The instructions are also executable to identify a first 3D action transpiring in 3D space, use the first app to convert the first 3D action into a first 2D action, and provide the first 2D action to a second app executing at the first device. The second app is different from the first app.

### FIELD

The disclosure below relates to technically inventive, non-routine solutions that are necessarily rooted in computer technology and that produce concrete technical improvements. In particular, the disclosure below relates to techniques for conversion of three dimensional (3D) virtual interactions into two dimensional (2D) actions.

### BACKGROUND

As recognized herein, head-mounted augmented reality (AR) and virtual reality (VR) headsets are growing in terms of adoption and technological sophistication and can provide an immersive experience for their users. As also recognized herein, to facilitate the immersive experience, these cross-reality devices/smart glasses often come with their own software development kit (SDK) to build 3D applications to use with the headsets themselves.

As further recognized herein, many of the headset devices are tethered to a mobile phone or other compute unit to help with the processing. However, the disclosure below recognizes that, currently, native 2D apps that run on the mobile device itself cannot adequately present their content on the headsets or deal with 3D user interactions as the 2D apps are not designed for such use. Instead, they are designed only for mobile device use and for touch-based interactions on flat touch-enabled displays. Thus, these apps do not currently work with immersive AR/VR interactions in the 3D spatial environment as the 3D SDK referenced above does not know how to handle them. There are currently no adequate solutions to the foregoing computer-related, technological problem.

### SUMMARY

Accordingly, in one aspect at least a first device includes at least one processor and storage accessible to the at least one processor. The storage includes instructions executable by the at least one processor to execute a first application (app) at the first device, where the first app is configured for converting actions in three dimensional (3D) space into actions in two dimensional (2D) space. The instructions are also executable to identify a first 3D action transpiring in 3D space, use the first app to convert the first 3D action into a first 2D action, and provide the first 2D action to a second app executing at the first device. The second app is different from the first app.

Thus, in certain example implementations the second app may be a 2D app configured to present first content in 2D coordinates on a non-headset display.

Also in certain example implementations, the first app may be embodied in a first software development kit (SDK), and the first app may identify the first 3D action based on input from a second SDK different from the first SDK. If desired, the second SDK may be an SDK for a headset to present second content in 3D coordinates, the first 3D action may be associated with the second content, the second content may be associated with the first content, and the second SDK may be configured to stereoscopically present the second content as 3D images according to the 3D coordinates. Also if desired, the first and second SDKs may both be executed at the first device. In certain examples, the first device may include a mobile device and/or the headset.

Also in some example embodiments, the instructions may be executable to use the first app to convert the first 3D action into a first 2D action at least in part by converting texture coordinates for the first 3D action into pixel coordinates for the first 2D action.

In various examples, the first 3D action may include a select action, a long press action, a back action, a scroll action, and/or a text input action. Additionally, if desired the first 3D action may be identified using a gaze pointer, ray casting, gesture recognition, and/or voice recognition.

In another aspect, a method includes executing a first application (app) at a first device, where the first app is configured for converting actions in three dimensional (3D) space into actions in two dimensional (2D) space. The method then includes identifying a first 3D action transpiring in 3D space, using the first app to convert the first 3D action into a first 2D action, and providing the first 2D action to a second app executing at the first device. The second app is different from the first app.

In certain examples, the method may include using the first app to convert first coordinates for the first 3D action into second coordinates for the first 2D action and then providing the second coordinates to the second app. The first coordinates may include texture coordinates, and the second coordinates may include pixel coordinates.

Additionally, if desired the first 3D action may include a select action, a long press action, a back action, a scroll action, and/or a text input action.

Also in certain examples, the second app may be a 2D app configured to present first content in 2D coordinates.

If desired, the first app may be embodied in a first software development kit (SDK), and the first app may identify the first 3D action based on input from a second SDK different from the first SDK. The second SDK may be an SDK configured to present second content in 3D coordinates.

In still another aspect, at least one computer readable storage medium (CRSM) that is not a transitory signal includes instructions executable by at least one processor to execute a first application (app) at a first device, where the first app is configured for converting actions in three dimensional (3D) space into actions in two dimensional (2D) space. The instructions are also executable to identify a first 3D action transpiring in 3D space, use the first app to convert the first 3D action into a first 2D action, and provide the first 2D action to a second app executing at the first device. The second app is different from the first app.

Accordingly, in various example implementations the instructions may be executable to use the first app to convert first coordinates for the first 3D action into second coordinates for the first 2D action and then provide the second coordinates to the second app. In certain examples, the first coordinates may include texture coordinates and the second coordinates may include pixel coordinates.

Still further, if desired the second app may be a 2D app configured to present content in 2D coordinates, and the first app may identify the first 3D action based on input from a third app. The third app may be different from the first and second apps. For example, the third app may be a 3D app configured for presenting content in 3D coordinates.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system consistent with present principles;

FIG. 2 is a block diagram of an example network of devices consistent with present principles;

FIG. 3 illustrates an example headset that may be used to present an AR, MR, or VR presentation consistent with present principles;

FIG. 4 is a schematic of example hardware and software architecture for content rendering consistent with present principles;

FIG. 5 shows an example texture canvas with graphical user interface (GUI) elements consistent with present principles;

FIG. 6 demonstrates a pixel coordinate system consistent with present principles;

FIG. 7 demonstrates a 3D texture coordinate system consistent with present principles;

FIG. 8 is a schematic demonstrating physics raycasting that may be done on a 3D texture to obtain 3D coordinates at which a user is looking consistent with present principles;

FIG. 9 is an example 3D view of a keyboard being rendered in 3D space consistent with present principles; and

FIG. 10 illustrates example logic in example flow chart format that may be executed by a mobile device or other device consistent with present principles.

### DETAILED DESCRIPTION

Among other things, the detailed description below recognizes that it is desirable for 2D mobile apps (designed for 2D space rendered on a flat screen display as may be built using a mobile device SDK such as Android's SDK) to be run in a 3D virtual environment in cross-compatible fashion. The 2D app might be Google's Chrome or Microsoft's Teams, for example. The detailed description below further recognizes that it is desirable to not require 2D app programmers to change the functioning of the 2D app itself as this is technologically complex if even possible given the numerous different types of 3D SDKs used in different headsets as the 3D SDKs are often manufacturer-specific. Likewise, the detailed description below recognizes that it is desirable to not require the 3D SDK programmers to change the functioning of the 3D SDK itself as this too is technologically complex and inhibiting.

App Space is therefore discussed below as an example of an app that may be used to make immersive 3D interactions possible for 2D apps. App Space may therefore be a mobile-based app that renders the 2D apps in a spatial environment and takes care of converting coordinates for the spatial coordinate system to coordinates for the 2D coordinate system in runtime. An app repositioning system is also disclosed as part of App Space to place the apps in three-dimensional spatial environment. Converted interactions can be extended to all the 3D interactions provided by the underlying SDK for the headset, such as raycast, scroll, swipe, long-press, double tap, gesture and voice.

Thus, in one example App Space may first render the 2D app(s) in a 3D spatial environment so that the rendered apps appear floating in front of the user. Then, when the user performs an interaction using 3D spatial methods, App Space converts the 3D interaction method and the 3D spatial coordinates at which the interaction occurred to a 2D coordinate system and interaction method recognizable by the 2D mobile app.

Accordingly, App Space may intercept the 3D AR coordinates from a 3D cursor and convert them to 2D coordinates, and covert all AR interactions such as AR clicks, AR scrolls, and AR text input to 2D app interactions such as “phone touches”/keyboard events. This architecture of App Space may therefore be flexible and leverage the capability of the headset's underlying 3D SDK, native APIs and 3D engine, making App Space's architecture open for many different platforms. In some specific examples, App Space may even be established by a 3D Container App for 2D/3D conversion, the underlying native 3D SDK of the headset itself for stereoscopic rendering and identifying/processing 3D user inputs (e.g., Lenovo's A3 Home and/or Unity), and an App Space Service. The components of coordinate conversion and interactions may work for other platforms too (e.g., not just Android-based mobile devices but also Mac and Linux-based devices using appropriate programming code for those other platforms).

It may therefore be appreciated that a 3D version of a 2D app need not exist for 3D rendering, and that nothing in the underlying 2D app itself need be customized either. Instead, the 2D app/content may be rendered in a 3D container, and the 2D app may not even know that it is being rendered in 3D space. Rather, the 2D app continues to assume it is operating per 2D pixel coordinates.

Interactions in 3D using App Space may be done per the following examples:

As one example, a 3D pointer, such as a cursor located in the center of the user's field of view (FOV) like a 3D Gaze pointer or a Raycast emanating from an attached device (e.g., phone), may be used and serve as a 3DoF controller.

Other selection methods may include a touchpad on a phone/mobile screen that accepts tap and swipe inputs (e.g., provided by a 2D companion app), a hardware button located on the attached compute/mobile device (e.g., phone, compute pack, etc.), hand gestures, and voice commands.

Keyboard key presses may also be used, such as from Android's native on-screen keyboard or from an AR keyboard.

When an interaction event occurs, App Space may do the following in various examples:

First, convert the coordinates of the 3D pointer (cursor or raycast) to corresponding screen coordinates.

Convert the 3D selection method (tap, scroll, etc.) to one understandable by the 2D app.

Inject the respective interaction event to the underlying 2D app.

In the case of key press, these events may be received either via native on-screen keyboard or via AR keyboard and may be injected to the currently-selected text input field of the 2D app's virtual display.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may also be embodied in a non-transitory device that is being vended and/or provided that is not a transitory, propagating signal and/or a signal per se (such as a hard disk drive, solid state drive, CD ROM or Flash drive). The software code instructions may also be downloaded over the Internet. Accordingly, it is to be understood that although a software application for undertaking present principles may be vended with a device such as the system 100 described below, such an application may also be downloaded from a server to a device over a network such as the Internet.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

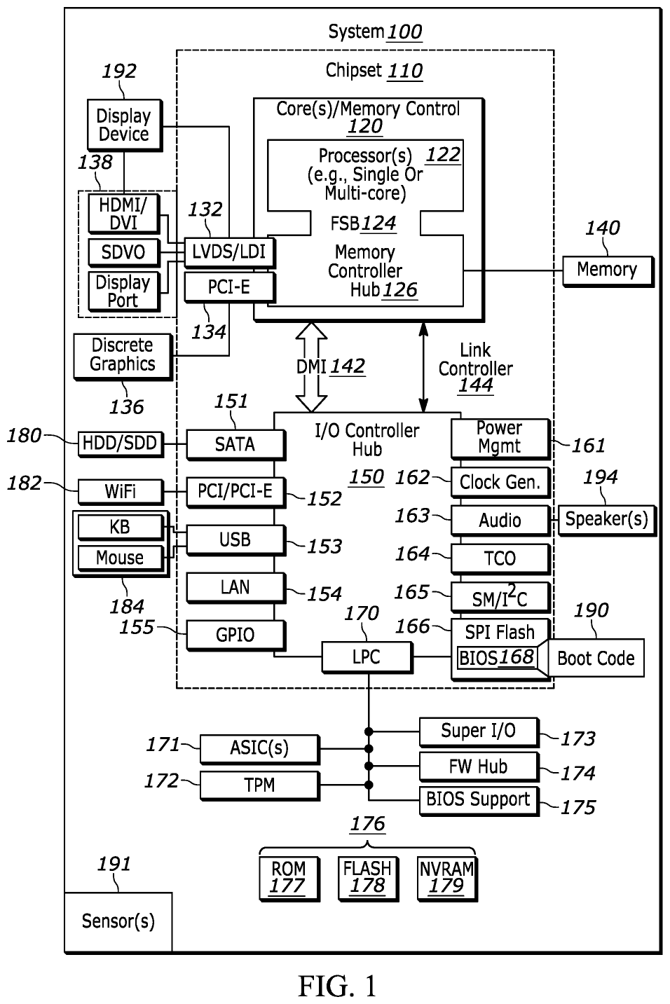

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre® or ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (×16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

As also shown in FIG. 1, the system 100 may include one or more sensors 191. The sensors 191 may include, for example, one or more cameras that gather images and provide the images and related input to the processor 122. The camera(s) may be webcams and/or digital cameras, but may also be thermal imaging cameras, infrared (IR) cameras, three-dimensional (3D) cameras, and/or cameras otherwise integrated into the system 100 and controllable by the processor 122 to gather still images and/or video. Thus, for example, one or more forward-facing cameras might be on a headset being worn by a user so that the system 100 may execute computer vision (e.g., for 3D real-world location tracking), and one or more inward-facing cameras might also be on the headset for eye tracking.

In addition to or in lieu of the foregoing, the sensors 191 may include one or more inertial measurement sensors that might be included in an inertial measurement unit (IMU) for location tracking (e.g., dead reckoning). For example, the system 100 may be embodied in a headset and the inertial measurement sensors may be located on the headset. Example inertial measurement sensors include magnetometers that sense and/or measure directional movement of the system 100 and provide related input to the processor 122, gyroscopes that sense and/or measure the orientation of the system 100 and provide related input to the processor 122, and accelerometers that sense acceleration and/or movement of the system 100 and provide related input to the processor 122.

Additionally, though not shown for simplicity, in some embodiments the system 100 may include an audio receiver/microphone that provides input from the microphone to the processor 122 based on audio that is detected, such as via a user providing audible input to the microphone as a voice command as described herein. The system 100 may also include a global positioning system (GPS) transceiver that is configured to communicate with at least one satellite to receive/identify geographic position information and provide the geographic position information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

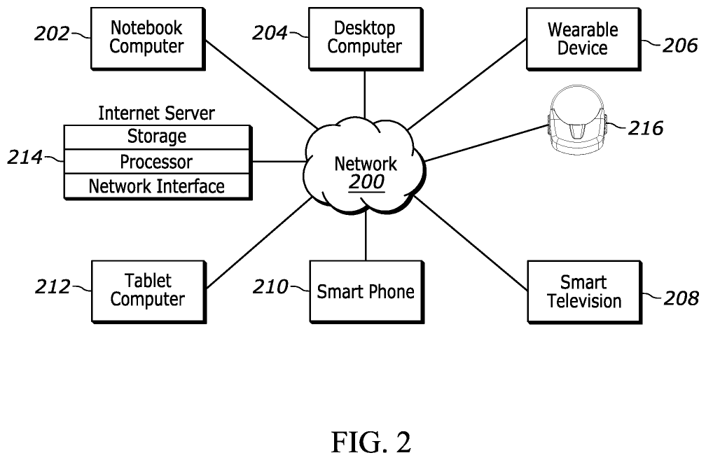

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above. Indeed, any of the devices disclosed herein may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, a headset 216, and a server 214 such as an Internet server that may provide cloud storage accessible to the devices 202-212, 216. It is to be understood that the devices 202-216 may be configured to communicate with each other over the network 200 to undertake present principles.

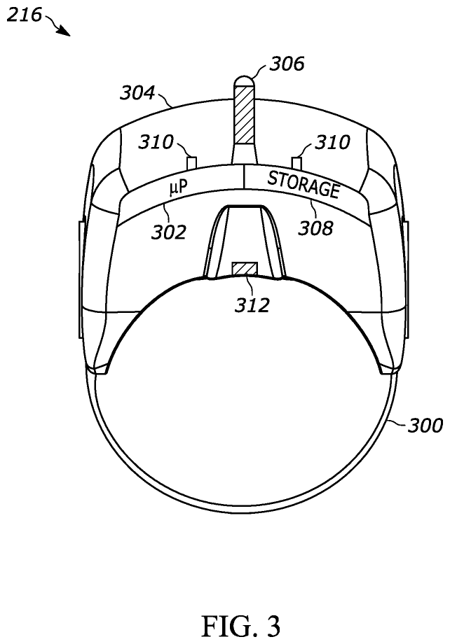

Now describing FIG. 3, it shows a top plan view of an example headset consistent with present principles, such as the headset 216 referenced above. The headset 216 may include a housing 300, at least one processor 302 in the housing 300, and a non-transparent or transparent “heads up” display 304 accessible to the at least one processor 302 and coupled to the housing 300. The display 304 may for example have discrete left and right eye pieces as shown for presentation of stereoscopic images and/or 3D virtual images/objects using augmented reality (AR) software, virtual reality (VR) software, and/or mixed reality (MR) software.

The headset 216 may also include one or more forward-facing cameras 306. As shown, the camera 306 may be mounted on a bridge portion of the display 304 above where the user's nose would be so that it may have an outward-facing field of view similar to that of the user himself or herself while wearing the headset 216. The camera 306 may be used for SLAM, computer vision, image registration, spatial mapping, etc. to track movements of the wearer/headset 216 within real-world space and map the movements to virtual space. The camera 306 may also be used for gesture recognition to recognize gestures made by the user using their hand, arm, etc. consistent with present principles. However, further note that the camera(s) 306 may be located at other headset locations as well. Also note that in some examples, inward-facing cameras 310 may also be mounted within the headset 216 and oriented to image the user's eyes for eye tracking while the user wears the headset 216 (e.g., to determine where a user is looking in 3D space to select a real world or graphical object).

Additionally, the headset 316 may include storage 308 accessible to the processor 302 and coupled to the housing 300, a microphone 312 for detecting audio of the user speaking voice commands, and still other components not shown for simplicity such as a network interface for communicating over a network such as the Internet and a battery for powering components of the headset 216 such as the camera(s) 306. Additionally, note that while the headset 216 is illustrated as a head-circumscribing VR headset, it may also be established by computerized smart glasses or another type of headset including other types of AR and MR headsets. For example, the headset may be established by an AR headset that may have a transparent display that is able to present 3D virtual objects/content.

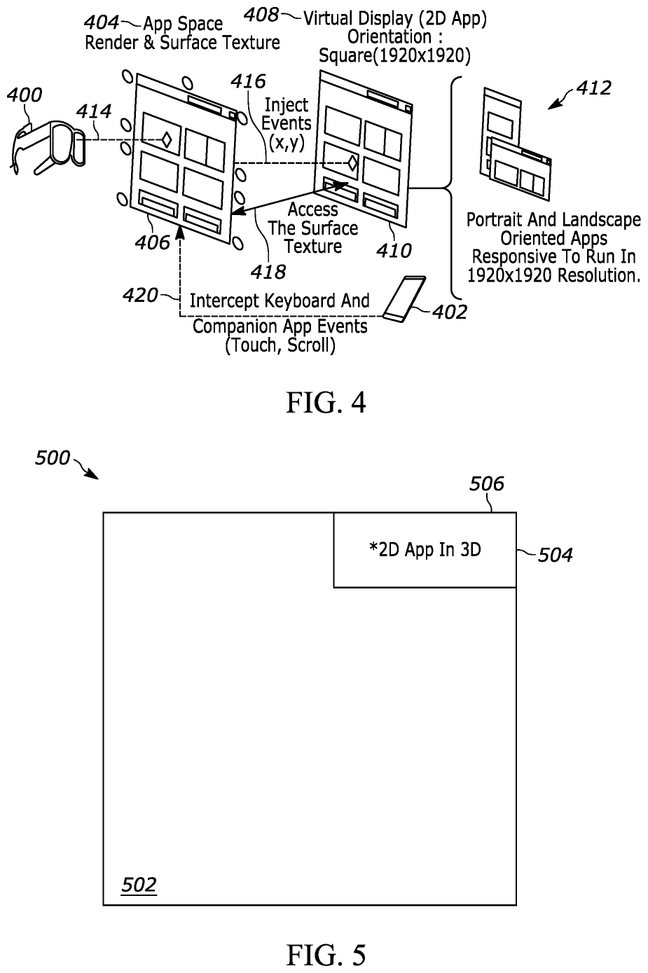

Before describing FIG. 4, it is to be understood that an app sometimes called App Space/AppSpace below may handle coordinate conversions and action/event translations between a headset's own SDK that might be provided by the headset's manufacturer (and that presents 3D content stereoscopically and manages 3D user interactions) and a 2D app operating on a connected smartphone. Thus, App Space may make immersive AR/VR/MR interactions possible for 2D apps that have not been configured for 3D space. App Space may therefore render the 2D apps in a 3D spatial environment, as well as convert 3D coordinates in the 3D spatial coordinate system into 2D coordinates in the 2D coordinate system at runtime (and vice versa). Thus, an app repositioning system is enabled by App Space to place the 2D apps in the 3D spatial environment. App Space's coordinate conversions can be extended to all the interactions afforded by the underlying 3D headset SDK, such as raycast, scroll, swipe, long-press, double tap, gesture and voice.

Now specifically in reference to FIG. 4, it shows a schematic of example hardware and software architecture. Thus, a headset 400 is shown and may be similar to the headset 216 described above. A mobile device 402 is also shown, where the mobile device 402 may be a smartphone, tablet computer, laptop computer, or other computing device.

FIG. 4 also shows that a first app 404— App Space in non-limiting examples—may execute at the device 402 to stereoscopically render a surface texture/canvas 406 in 3D coordinates on the display of the headset 400 and hence to a wearer of the headset 400. The device 402 may also execute a second app 408 that is already configured to present content in 2D coordinates on the display of the device 402 itself. Thus, the 2D app may be executed for the device 402 to present a virtual display 410 in, for example, square orientation in 1920×1920 pixel format once portrait and/or landscape-oriented presentations 412 of the 2D app have been converted into square orientation by the device 402 (e.g., by App Space itself, and/or by the guest operating system such as Android that is running on the device 402 including but not limited to APIs of Android (an Android Virtual Display Service)). The content of the virtual display 410 may then act as the base for the content of the surface texture/canvas 406 that is rendered in 3D, with it being reiterated that the virtual display 410 may be generated by the operating system of the mobile device itself (e.g., Android). The virtual display 410 (and by extension, the texture/canvas 406) may also have the same frame rate (e.g., 60 Hz) as the frame rate for the underlying 2D app itself as would be used to present the 2D app's content on the mobile device's own display.

Thus, as shown by line 414, the surface texture 406 is projected into the user's 3D view while wearing the headset 400 (by App Space 404 itself or after App Space 404 provides the surface texture 406 to the headset's own 3D SDK app for 3D rendering), with App Space 404 initially accessing/generating the surface texture/canvas 406 using the virtual display 410 of the 2D app 408 (as demonstrated by line 418). Additionally, 3D events and actions taken by the user in 3D space while interacting with the 3D virtual environment may be injected into the 2D virtual display space 410 running on the device 402 in x,y pixel coordinates once converted into those coordinates by App Space 404, as demonstrated by line 416. App Space 404 may also intercept keyboard and other app events executing at the companion 2D app 408 and represent them in the 3D surface texture 406, as represented by line 420. For instance, touches to the touch-enabled display of the device 402 may be intercepted, as may scroll events.

Accordingly, as understood herein, in non-limiting examples App Space 408 may be a 3D app package and mobile service that bring 2D apps into a 3D space app. The App Space service may wrap underlying OS Virtual Display application programming interfaces (APIs). 2D apps may be opened in the secondary virtual display 410 for which the surface texture is accessible to App Space in a 3D engine. App Space may thus render the surface texture 406 in 3D space and manage the texture 406 with additional user interface (UI) controls. App Space may detect gaze, raycast, keyboard, and keypress events from any buttons on the head-mounted headset 400 itself or even other controller devices (such as 3D hand-held controllers) itself and/or via the headset's own SDK for 3D rendering. All the detected events may then be injected to the respective virtual display 410 at the intercepted coordinates and thus to the underlying 2D app 408.

Also note that, using App Space, multiple 2D apps can be rendered at the headset 400 concurrently and placed in the 3D space along a 360-degree field of view for the user's convenience. Thus, the 2D apps may be assigned a spatial anchor in 3D coordinates to keep the 2D content virtually presented in 3D at a particular real world location (for AR) or virtual world 3D location (for VR).

Thus, in one example embodiment per the schematic of FIG. 4, the following environment may be used (although present principles may also be extended to other setups as well). First, the head mounted display device 400 itself may be a Lenovo ThinkReality A3 device. The 3D engine that is used may be the Unity 3D engine. The headset SDK itself may be the Android SDK and/or Lenovo ThinkReality SDK. The controlling software may be the app running on the device 402, such as App Space itself. In the present non-limiting example, the computing device 402 itself is a Motorola g100 running a version of the Android operating system (OS). The virtual display technology that is used may be Android Virtual Display and/or native APIs from the underlying OS (e.g., Virtual Display APIs from underlying OS/Native layer such as Android).

Now in reference to FIG. 5, an example App Space canvas 500 is shown that may be similar to the surface texture/canvas 406 described above. Content from the 2D app has been omitted for simplicity but may be located in the main part 502 of the canvas 500. Note that here the canvas 500 also establishes a graphical user interface (GUI) and that, as part of this GUI, a section 504 may be presented. The section 504 may include a text indication 506 that a 2D app running on the connected mobile device is being presented stereoscopically in 3D at the headset.

Now describing coordinate conversion in more detail, note that App Space may intercept the 3D spatial coordinates (e.g., from the headset's manufacturer-provided SDK) and convert them to 2D coordinates. Also note here that App Space may not just convert 3D coordinates to 2D coordinates to provide to the 2D app running on the mobile device but may also convert 2D coordinates from the 2D app itself into 3D coordinates for passing back to the headset's 3D SDK for 3D renderings.

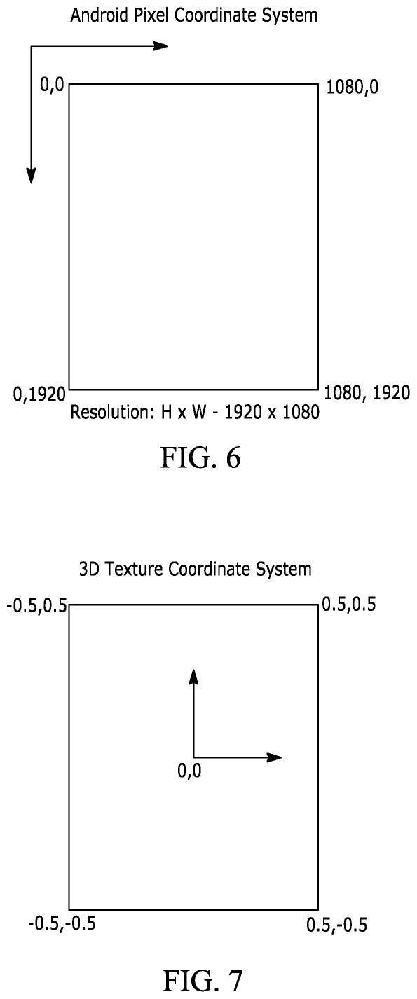

Before describing the coordinate calculations in detail, also note more generally that for the virtual display 2D source coordinate system, Android images may be formed by pixels and represented in the pixel coordinate system, defined by height×width as shown in FIG. 6. As shown, an example 2D resolution of 1920×1080 is shown, with coordinates being at the top left corner of the content, 1080,0 coordinates being at the top right corner, 0, 1920 coordinates being at the bottom left corner, and 1080, 1920 coordinates being at the bottom right corner.

As for the 3D spatial coordinate system, 3D textures may be bitmap images that have different origin and axis arrangements as shown in FIG. 7. As shown, 0,0 coordinates are located in the middle, with the bounds defined by −0.5 to 0.5 coordinates as also shown. E.g., the upper left may be established by −0.5,0.5 coordinates, the upper right may be established by 0.5, 0.5 coordinates, the bottom left may be defined by −0.5,−0.5 coordinates, and the bottom right may be defined by 0.5,−0.5 coordinates.

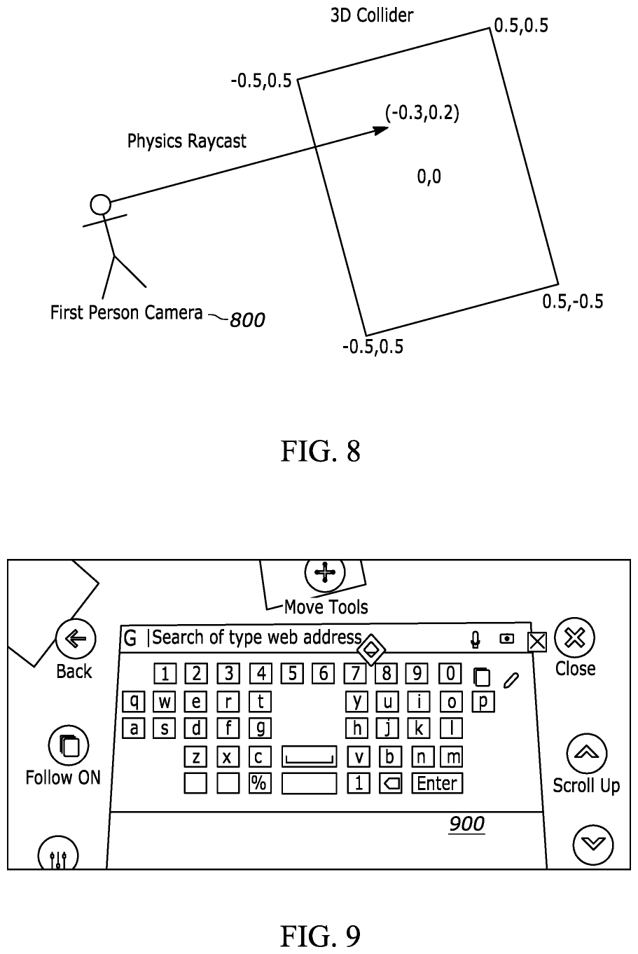

Thus, in order to perform clicks or selections on the 2D app at the correct places (e.g., represent 3D eye gaze select actions as 2D touch events to the 2D app), a physics raycasting may be done on the 3D texture to obtain the 3D coordinates that the user is looking at as depicted in FIG. 8. In the present example, the first person camera 800 from the headset is used to execute the raycast to identify a point in 3D space with which the user's eye gaze collides. In the present example, the point is −0.3,0.2.

Then, with the mobile device knowing the 3D coordinates, a coordinate conversion may be performed from 3D texture space into 2D pixel space using the following functions:

Pixel X=F(Texture X), where F=(0.5+Texture X)*W

Pixel Y=F(Texture Y), where F=(0.5−Texture Y)*H

For example, (−0.3,0.2) in texture space would translate to (216, 576) as calculated below, given that width=1080 and height=1920:

Pixel X=(0.5+(−0.3))*1080=216

Pixel Y=(0.5−(0.2))*1920=576

Also note that the reverse calculation of (216,576) in 2D pixel space may translate into (−0.3,0.2) in texture space as given by the following functions:

Texture X=F(Pixel X), where F=(Pixel X/W)−0.5

Texture Y=F(Pixel Y), where F=0.5−(Pixel Y/H)

With the coordinate conversions themselves being set forth, immersive interactions for which the conversions may be used will now be discussed.

Interactions in 3D space (that may be translated to 2D interactions using App Space) may occur using any number of different 3D input modalities, including but not limited to gaze pointer, raycast, hand/arm gestures, and voice input.

For the gaze pointer, the pointer may track either the x-y middle of the user's field of view (FOV) and/or track the user's eyes themselves so that whatever the pointer is located on becomes the object for selection (with the real-world or virtual location of the object already being known). This concept is sometimes referred to as “collision”. In non-limiting examples, the gaze pointer may show a red dot on the headset display and in the user's FOV, and the dot may move in 3D space with head movement so that a selection of an object on which the dot falls can happen various ways. For example, the dot and/or user's gaze may be required to remain fixed on the object for a threshold amount of time for selection (such as two seconds) for a 2D touch event to then be translated by App Space for the selected object. Additionally or alternatively, the dot and/or user's gaze may be placed on the object to be selected and then the selection input may be provided at the connected mobile device using the 2D app itself or even the firmware for its touch-enabled display such that a touch event at the mobile device's touch-enabled display establishes a selection of the 3D object on which the gaze pointer is fixed (to then be translated into a 2D touch event). As yet another example, the dot and/or user's gaze may be placed on the object to be selected and then the selection input may be provided by the user selecting a “select” button or other depressable hardware button on the headset itself to then be translated into a 2D touch event.

For raycast, a ray may be cast along the longitudinal axis of the mobile device itself and used as controller or pointer in 3D space, where a physical ray is visible in virtual space. The ray may originate from the mobile device itself so that a user can control it by moving the mobile device relative to headset to place the other end of the ray on an object for selection (with the real-world or virtual location of the object already being known), establishing a collision. Thus, note that for raycast the user would not see a cursor (e.g., red dot) like for the gaze pointer but would instead see a 3D laser ray extending through space in three dimensions. But note that here too once an object is selected based on where the distal end of the ray falls and based on additional input such as those immediately described above (e.g., touch input to the mobile device display to select from the 2D app presentation itself or selecting a “select” button on the headset), the 3D select event may be converted to a 2D touch event.

As for gesture and voice input for immersive interactions, these inputs may be identified and processed using gesture recognition and voice recognition, respectively, to then translate the 3D interaction into a 2D interaction.

The foregoing interactions and input modalities may be supported for any 3D app using the headset manufacturer's SDK (e.g., the ThinkReality SDK) and/or App Space itself. Events may thus be injected via Virtual Display APIs to the underlying 2D app. Below are descriptions of how different interactions may be performed in App Space or whatever 3D to 2D conversion app is being used.

For click/select interactions, App Space may inject a finger touch event at pixel coordinates converted from the cursor pointer location in Unity when a gaze select event or companion app tap event or other event occurs. The following is Android code for the injection:

```
  public void click(int displayID, final int x, final int y) {
  long 26owntime = SystemClock.uptimeMillis( );
  //These injectMotionEvents is to perform Tap
  injectMotionEvent(displayID, MotionEvent.ACTION_DOWN, 26 owntime,
26owntime, x, y);
      long eventTime = SystemClock.uptimeMillis( );
      injectMotionEvent(displayID, MotionEvent.ACTION_UP, 26 owntime,
eventTime, x,y);
    }
```

For longpress interactions the long press may be supported by long-pressing of a button on the headset (e.g., the Lenovo A3 glass Center Key button) for a threshold amount of time such as two seconds, or a longpress on the companion mobile app/display/trackpad. App Space may then inject finger touch events (ACTION_DOWN using finger, hold it down and then after a delay lifting finger using ACTION_UP) according to the following Android code:

```
  public void longPress(int displayID, final int x, final int y) {
  long 26owntime = SystemClock.uptimeMillis( );
  injectMotionEvent(displayID, MotionEvent.ACTION_DOWN, 27 owntime,
27owntime, x, y);
    Thread.sleep(ViewConfiguration.getLongPressTimeout( ) +
LONG_PRESS_TIMEOUT_BUFFER);
      27owntime = SystemClock.uptimeMillis( );
      long eventTime = SystemClock.uptimeMillis( );
      injectMotionEvent(displayID, MotionEvent.ACTION_UP, 27 owntime,
eventTime, x, y);
  }
```

For back button interaction, back functionality may be supported in an AR user interface (UI) at the headset (e.g. Lenovo A3 using App Space) as well from the 2D companion app/mobile device itself. App Space may thus inject a keyboard event with KEYCODE_BACK into the 2D app as follows:

```
  public void goBack(int displayID) {
  serviceConnection.injectKeyEvent(new KeyEvent(ACTION_DOWN,
KEYCODE_BACK), displayID);
    serviceConnection.injectKeyEvent(new KeyEvent(ACTION_UP,
KEYCODE_BACK), displayID);
  }
```

Note that similar programming language and a corresponding keycode may be used for a “close” command to close a window or other graphical object.

For scroll interactions, scrolling may be supported in an AR UI at the headset (e.g., Lenovo A3 using App Space) by injecting mouse scroll events (ACTION_SCROLL for TOOL_TYPE_MOUSE). Thus, AR UI scrolls via Scroll Up/Down buttons may be performed as a fixed-step scroll. Scrolling from the 2D companion app trackpad or touch-enabled display (e.g., up/down/left/right scroll gestures) may also be supported as continuous scrolls and App Space may thus inject scroll events based on the velocity and distance covered on trackpad.

For double tap/double-click interactions, double taps on the 2D companion app/mobile device display may also be supported similar to the click/select interactions set forth above but to establish a 2D double tap.

Turning now to text input modalities for conversion to 2D coordinates for passing of text input to the 2D app on the mobile device, the initial text input may be performed via an on screen 3D keyboard in AR/VR as presented at the headset, or via a keyboard as presented on the display of the mobile device. If the input is provided to the native 3D keyboard or to the mobile device keyboard, the key input for whatever key is selected may be passed to the 2D app. For input to a keyboard from a 2D app executing at the mobile device (or from the mobile device itself) but as presented in 3D virtual space on the headset display, App Space may intercept all the key events and inject to the focused Virtual Display using Android's virtual display APIs according to the coordinate conversions discussed above (e.g., based on the 3D coordinates of a gaze pointer or raycast being used for key selection).

An example keyboard 900 is shown in FIG. 9 that is from a 2D app but that is enlarged and presented in 3D space using App Space, with a gaze pointer/cursor 902 shown as not currently positioned to collide with any key of the keyboard 900. But once positioned on a key and select input provided (e.g., by leaving the pointer 902 on the key for a threshold amount of time or pressing a “select” button on the headset with the pointer 902 colliding with the intended key), App Space may perform a coordinate conversion for the 2D app to receive the key input based on selection in 3D space.

Still in terms of different 3D user interactions that may be injected into a 2D app as a 2D action, the following table further illustrates. This table may be thought of as a key map indicating how various user interactions are converted to Android terms for injection into an Android-based 2D app. Thus, the table below sets forth various events and their corresponding Android mapping. The Android Key codes may be provided through the Android SDK. Thus, the appropriate events may be generated programmatically for each type of user interaction indicated in the event column as follows:

| Event | Android Key Code | Comments |
|---|---|---|
| Click | MotionEvent.ACTION_DOWN | Two motion events are |
| | MotionEvent.ACTION_UP | programmatically generated and |
| | | passed on, first event |
| | | ACTION_DOWN followed by |
| | | ACTION_UP |
| Hover | MotionEvent.ACTION_HOVER_MOVE | Whenever gaze movement is |
| | | detected over the AppSpace canvas |
| | | an ACTION_HOVER_MOVE |
| | | event is programmatically |
| | | generated and fired |
| Keyboard | KeyEvent.ACTION_DOWN | Whenever a key is pressed in AR |
| | KeyEvent.ACTION_UP | Keyboard, two key events are |
| | | generated and fired |
| | | programmatically, |
| | | ACTION_DOWN followed by |
| | | ACTION_UP. Both events will |
| | | also have the same key code of the |
| | | key being pressed. For example, |
| | | for the enter key press, |
| | | “KeyEvent.KEYCODE_ENTER” |
| | | will be present in both |
| | | ACTION_DOWN and |
| | | ACTION_UP |
| Long | MotionEvent.ACTION_DOWN | Similar to click, but in between |
| Click | Thread. Sleep(200) | ACTION_DOWN and |
| | MotionEvent.ACTION_UP | ACTION_UP, a programmatical |
| | | delay (sleep) of 200 ms is |
| | | introduced to simulate interval |
| Back | KeyEvent.ACTION_DOWN | Similar to keyboard events, but the |
| | KeyEvent.ACTION_UP | generated event will have the key |
| | | code as |
| | | KeyEvent.KEYCODE_BACK |
| Horizontal | MotionEvent.AXIS_HSCROLL | First AXIS_HSCROLL will be |
| Scroll | MotionEvent.ACTION_SCROLL | called to set the amount of scroll |
| | | followed by the |
| | | ACTION_SCROLL |
| | | programmatically |
| Vertical | MotionEvent.AXIS_VSCROLL | First AXIS_VSCROLL will be |
| Scroll | MotionEvent.ACTION_SCROLL | called to set the amount of scroll |
| | | followed by the |
| | | ACTION_SCROLL |
| | | programmatically |
| Fling | MotionEvent.ACTION_DOWN | First ACTION_DOWN followed |
| | MotionEvent.ACTION_MOVE | by a bunch of ACTION_MOVE |
| | MotionEvent.ACTION_UP | and finally ACTION_UP. All |
| | | events generated and fired |
| | | programmatically |
| Double | MotionEvent.ACTION_DOWN | Similar to click, but fired twice in |
| Tap | MotionEvent.ACTION_UP | short intervals programmatically |

Turning now to the presentation of alerts and notifications in 3D as provided or initiated by 2D apps running on the mobile device, the handling of mobile alerts and notifications may be performed using different rendering layers so that important notification always come on the top of the user's FOV of 3D space. App Space may thus intercept 2D app-level notification and show them stereoscopically on the headset display (e.g., at the top of the window for the 2D app but as presented in 3D space as determined using the coordinate conversions above). A system notification canvas may also be used as part of App Space to show system-level notifications at runtime on the headset display, again at the top of the user's FOV or at another static location.

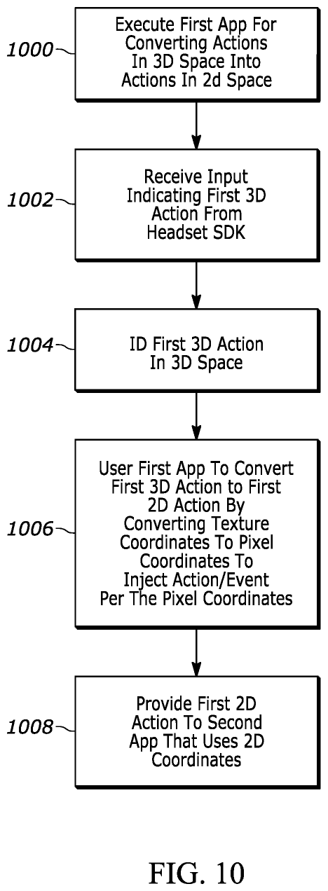

Referring now to FIG. 10, it shows example overall logic that may be executed consistent with present principles by a device such as the system 100, a mobile device, and/or a coordinating server in any appropriate combination. Beginning at block 1000, the mobile device may execute a first app (e.g., App Space) at the mobile device, where the first app may be configured for converting actions in 3D space into actions in 2D space. The logic may then move to block 1002.

At block 1002 the mobile device may receive input that indicates a first 3D action taken by the user in 3D space (e.g., as detected via the first app/App Space and/or as received from the headset's SDK as provided by the headset manufacturer for 3D renderings). Then at block 1004 the mobile device may actually identify the first 3D action transpiring in 3D space to, at block 1006, use the first app to convert the first 3D action into a first 2D action. This may be done by converting texture coordinates to pixel coordinates as set forth above to then inject the converted 2D action/event into the 2D app execution environment according to the converted pixel coordinates. Thus, at block 1008 the mobile device may provide/inject the first 2D action into a second app (a 2D app) executing at the mobile device. To reiterate, the second app may be different from the first app, with the first app being App Space according to the description above in certain non-limiting examples, and with the second app being a 2D app not configured for presenting content in 3D in non-limiting examples. Instead, the second app may be a 2D app configured to present first content in 2D coordinates on a non-headset display.

As for the first app such as App Space, in some embodiments the first app may itself be an SDK (e.g., that includes the ThinkReality SDK for A3 Glass as well as Unity), and thus the first app SDK may itself identify the first 3D action and/or identify the first 3D action based on input from a second SDK different from the first SDK that is being used to present an interactive 3D AR/VR environment. Thus, again note that the second SDK may be an SDK for the headset to present second content in 3D coordinates, with the first 3D action associated with the 3D second content and the second content being a 3D version/replication of the associated 2D first content. The second SDK may also thus be configured to stereoscopically present the second content as 3D images according to the 3D coordinates (e.g., in embodiments where App Space itself is not being used for 3D stereoscopic rendering).

Also note that in various examples, both the first and second SDKs may be executed at the mobile device. Additionally, in various examples the first 3D action may include a select action, a long press action, a back action, a scroll action, and/or a text input action. The first 3D action itself may be identified using a gaze pointer, ray casting, gesture recognition, and/or voice recognition.

App Space of whatever is being used as the first app/SDK may therefore make 2D apps work in a 3D spatial environment without porting any 2D app to a 3D app. The foregoing can therefore be extended to any 2D app including those for other platforms, SDKs, and devices.

It may now be appreciated that present principles provide for an improved computer-based user interface that increases the functionality and ease of use of the devices disclosed herein. The disclosed concepts are rooted in computer technology for computers to carry out their functions.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

1. At least a first device, comprising:
at least one processor; and
storage accessible to the at least one processor and comprising instructions executable by the at least one processor to:
execute a first application (app) at the first device, the first app configured for converting actions in three dimensional (3D) space into actions in two dimensional (2D) space, the first app using a virtual display generated by an operating system of a mobile device as a base for content rendered as part of a 3D canvas;
identify a first 3D action transpiring in 3D space;
use the first app to intercept, from a headset software development kit (SDK), data for the first 3D action and to convert the first 3D action into a first 2D action using the data, the data intercepted from the SDK as the data is sent from the SDK to a 3D app different from the first app and different from the SDK;
inject the first 2D action into the virtual display; and
execute a fourth app to present, at the mobile device, content of the virtual display and the 2D action, the fourth app being a 2D app, the fourth app being different from the first app, different from the SDK, and different from the 3D app.

2. The first device of claim 1, wherein the fourth app is configured to present content in 2D coordinates on a non-headset display.

3. The first device of claim 2, wherein the SDK is a first SDK, and wherein the first app is embodied in a second SDK different from the first SDK.

4. The first device of claim 3, wherein the first SDK is configured to stereoscopically present 3D images.

5. The first device of claim 4, wherein the first and second SDKs are both executed at the first device.

6. (canceled)

7. The first device of claim 4, comprising a headset at which the 3D images are presented.

8. (canceled)

9. The first device of claim 1, wherein the first 3D action comprises one or more of: a long press action, a back action, a text input action.

10. The first device of claim 1, wherein the first 3D action is identified using one or more of: gesture recognition, voice recognition.

11. A method, comprising:
executing a first application (app) at a first device, the first app configured for converting actions in three dimensional (3D) space into actions in two dimensional (2D) space, the first app using a virtual display generated by an operating system of a mobile device as a base for content rendered as part of a 3D canvas;
identifying a first 3D action transpiring in 3D space;
using the first app to intercept, from a headset software development kit (SDK), data for the first 3D action and to convert the first 3D action into a first 2D action using the data, the data intercepted from the SDK as the data is sent from the SDK to a 3D app different from the first app and different from the SDK;
injecting the first 2D action into the virtual display; and
executing a fourth app to present, at the mobile device, content of the virtual display and the 2D action, the fourth app being a 2D app, the fourth app being different from the first app, different from the SDK, and different from the 3D app.

12-13. (canceled)

14. The method of claim 11, wherein the first 3D action comprises one or more of: a long press action, a back action, a text input action.

15. The method of claim 11, wherein the fourth app is configured to present content in 2D coordinates.

16. The method of claim 15, wherein the SDK is a first SDK, and wherein the first app is embodied in a second SDK different from the first SDK.

17. At least one computer readable storage medium (CRSM) that is not a transitory signal, the at least one computer readable storage medium comprising instructions executable by at least one processor to:
execute a first application (app) at a first device, the first app configured for converting actions in three dimensional (3D) space into actions in two dimensional (2D) space, the first app using a virtual display generated by an operating system of a mobile device as a base for content rendered as part of a 3D canvas;
identify a first 3D action transpiring in 3D space;
use the first app to intercept, from a headset software development kit (SDK), data for the first 3D action and to convert the first 3D action into a first 2D action using the data, the data intercepted from the SDK as the data is sent from the SDK to a 3D app different from the first app and different from the SDK;
inject the first 2D action into the virtual display; and
execute a fourth app to present, at the mobile device, content of the virtual display and the 2D action, the fourth app being a 2D app, the fourth app being different from the first app, different from the SDK, and different from the 3D app.

18-19. (canceled)

20. The CRSM of claim 17, wherein the fourth app is configured to present content in 2D coordinates.

21-26. (canceled)

27. The first device of claim 1, wherein the content of the virtual display is presented on both a first display of a first device and a second display of the mobile device, the mobile device being different from the first device.

28. The first device of claim 27, wherein the first display is an electronic display of a headset.

29. The method of claim 11, comprising:
executing the first app to present the content of the virtual display on both a first display of a first device and a second display of the mobile device, the mobile device being different from the first device.

30. The method of claim 29, wherein the first display is an electronic display of a headset.

31. The CRSM of claim 17, wherein the content of the virtual display is presented on both a first display of a first device and a second display of the mobile device, the mobile device being different from the first device.

32. The CRSM of claim 31, wherein the first display is an electronic display of a headset.
